(19) United States
(12) Patent Application Publication
(10) Pub. No.: US 2003/0154325 A1
(43) Pub. Date: Aug. 14, 2003

(54) Method and system for producing personalized publications

(76) Inventor: Daniel C. Castle, Monmouth, OR (US)

Correspondence Address: HEWLETT-PACKARD COMPANY, Intellectual Property Administration, P.O. Box 272400, Fort Collins, CO, 80527-2400, US

(21) Appl. No.: 10/077,128

(22) Filed: Feb. 14, 2002

(51) Int. Cl. G06F 3/00

(52) U.S. Cl. 710/1

(57) ABSTRACT

A method and system for producing personalized publications is disclosed. A user selects a background image and a foreground image to be placed over the background image. The selected images are then merged to form the completed personalized publication. The personalized publication can then be transmitted to a destination location for viewing and subsequent printing by the user on either a one-time basis or a continuous fashion, based on information provided by the user.

### NOTICE OF COPYRIGHT

A portion of the disclosure of this document contains material which is subject to copyright protection. The copyright owner has no objection to the facsimile reproduction by anyone of the patent document or the patents disclosure, as it appears in the Patent and Trademark Office patent files or records, but otherwise reserves all copyright rights whatsoever.

### BACKGROUND OF THE INVENTION

Conventional vehicles for providing information to consumers include printed publications that are mass produced and distributed in either a point of sale fashion (i.e. newsstand) or through subscriptions. Magazines, books and newspapers are examples of such conventional publications. Although each of the foregoing is capable of providing information, they are essentially single-use publications; this is especially true for books. The information contained within these types of publications often becomes quickly outdated.

In addition to becoming quickly outdated, the entirety of the information presented in magazines and other publications also often contains additional information that is of little or no interest to the purchaser or reviewer. Thus, the purchaser may actually review only a small portion of the entire publication. Consequently, any advertising or other commercial content contained within the publication goes unnoticed. Accordingly, mass distributed publications are often ineffective in getting advertisers products or associated information to their target audience.

In addition to providing information and promoting products and services, consumers peruse magazines, newspapers and other publications for entertainment reasons. Comics and other lighthearted materials are the principal vehicle for providing written entertainment. A drawback associated with most comics, especially comics presented in mass-distributed publications (e.g. magazines and newspapers) is that they are generally presented in conjunction with additional material that is of little interest to the purchaser or reviewer. Moreover, the message being conveyed by the comic may also be outdated.

Non-current content sources of information, for example, calendars, cards and note paper, are generally used more to record information; not to entertain the user thereof. As such, their use may become limited if a person is not interested or otherwise motivated to use them.

### BRIEF DESCRIPTION OF THE DRAWINGS

The present invention, and the advantages and features provided thereby, will become better understood and appreciated upon review of the following detailed description of the invention, taken in conjunction with the following drawings, where like numerals represent like elements, in which:

FIG. 1 is a schematic block diagram of a system employing the personalized publication system according to the present invention;

FIG. 2 is a schematic block diagram of the publication/delivery engine of the system illustrated in FIG. 1;

FIG. 3 is a flowchart illustrating the operating steps performed by the publication/delivery engine when generating the publication template according to the present invention;

FIG. 4 is a schematic diagram illustrating the data structure corresponding to the staging area of the publication/delivery engine according to the present invention;

FIG. 5 is a schematic diagram illustrating the data structure corresponding to the delivery area of the publication/delivery engine according to the present invention;

FIG. 6 is a representation of an exemplary publication provided by the publication/delivery engine according to the present invention;

FIG. 7 is a representation of an alternate publication provided by the publication/delivery engine according to the present invention; and

FIG. 8 is a flowchart illustrating the operating steps performed by the publication/delivery engine when generating the publications illustrated in FIGS. 7 and 8.

### DETAILED DESCRIPTION OF THE INVENTION

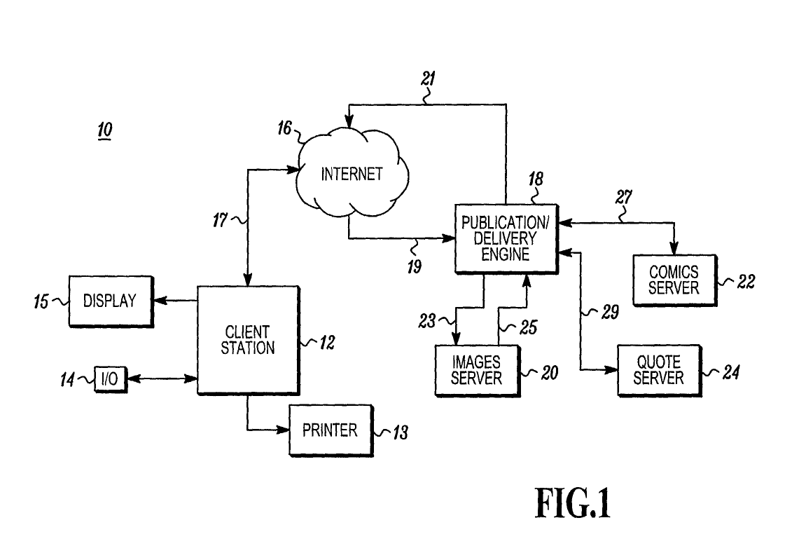

An exemplary personalized publication system, and corresponding method, that places user-defined content over a background containing, for example, a calendar, daily planner scheduler or note paper in accordance with the present invention will be introduced with reference to FIGS. 1-8. The content that is placed over the background can be, for example, a comic strip, a figure, a picture, etc. The personalized publication can then be automatically printed according to a user-defined schedule or, when requested, viewed in real-time and subsequently printed, if desired. It is a feature of the present invention that the user does not have to be involved with each individual selection of content; the present invention includes a process of going to a network resource and locating content of interest to the user based upon the user's previously entered preferences.

An exemplary network, employing the personalized publication system of the present invention is illustrated in FIG. 1. As shown, the network 10 includes a client station 12, having an input/output (I/O) device 14 coupled thereto. The input/output device 14 can include a mouse, joystick, keyboard or any other mechanism for allowing a user (not shown) to enter information into the client station 12. A peripheral device, such as a printer 13, is also coupled to the client station 12. The printer 13 is capable of printing out any information that is either entered by the user or received from the network, as will be described in greater detail below. A display device 15 is also coupled to the client station 12. The display device 15 can be a cathode ray tube (CRT) display, a flat panel display, a computer monitor or any suitable display device. In an exemplary embodiment, the display device 15 is a computer monitor.

The client station 12 can be any device that is capable of connecting to a network resource, such as publication/delivery engine 18, through a network connection 16. In an exemplary embodiment, the client station 12 is a personal computer that connects to network connection 16 by way of connection 17. In the embodiment illustrated in FIG. 1, the network connection 16 is the Internet. It will be appreciated by those of ordinary skill in the art that the network connection can be performed over a local area network (LAN), a wide area network (WAN) or additional land-line and wireless applications. The publication/delivery engine 18 is coupled to an image server 20 via transmission lines 23 and 25. The publication/delivery engine 18 is coupled to a comics server 22, via bidirectional transmission line 27 and also coupled to a quote server 24 via bi-directional transmission line 29. The publication/delivery engine 18 connects to network connection 16 through transmission lines 19 and 21.

The image server 20 has several images stored therein, each identified by a unique identifier, that are used in generating the personalized publications according to the method of the present invention. The images may include note paper with or without gradations, a to-do list, a daily planner, a monthly planner, etc. Each of the images maintained in the image server 20 are used as background images as will be described in greater detail below. The comics server 22 maintains several comic strips and/or individual comedic pieces, each identified by a unique identifier. The information maintained within the comics server 22 can be provided by a commercial enterprise or by individual users. The quotes server 24 may contain portions of famous quotes, or the quotes in their entirety; with each quote maintained therein being identified by a unique identifier. The quotes server 24 may also contain informative pieces or shorts relating to a variety of topics. The material maintained within the comics server 22 and the quotes server 24 are used as foreground information as will be described in greater detail below.

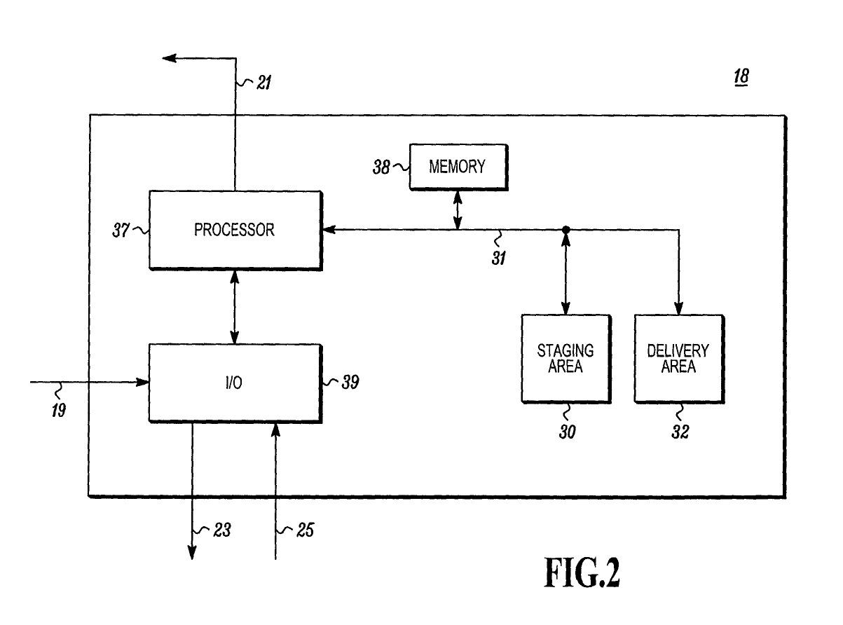

Referring now to FIG. 2, illustrated therein is an exploded schematic block diagram of the basic components that comprise the publication/delivery engine 18. As shown, the publication/delivery engine 18 includes a processor 37, capable of executing instructions maintained in and provided by a corresponding memory 38. An example of such instructions would be program code for generating and transmitting a personalized publication in accordance with the present invention. Also included within the publication/delivery engine 18 is an input/output port 39, capable of sending and receiving information and commands from a variety of sources. For example, the input/output port 39 is capable of receiving commands and information from the client station 12 (via network connection 16) on line 19 and the images server 20, via lines 23 and 25. The input/output port 39 is also responsible for transmitting information to the client station 12, for example, via transmission line 21. The publication/delivery engine 18 also includes a staging area 30, which is a data structure that stores data relating to the user-defined publication and a delivery area 32, which is a data structure that maintains the generated publication before such publication is transmitted to a requesting client station. The staging area 30 and the delivery area 32 are coupled to the processor 37 via internal bus 31. Although shown as being individual components, the staging area 30 and the delivery area 32 can be part of the memory 38.

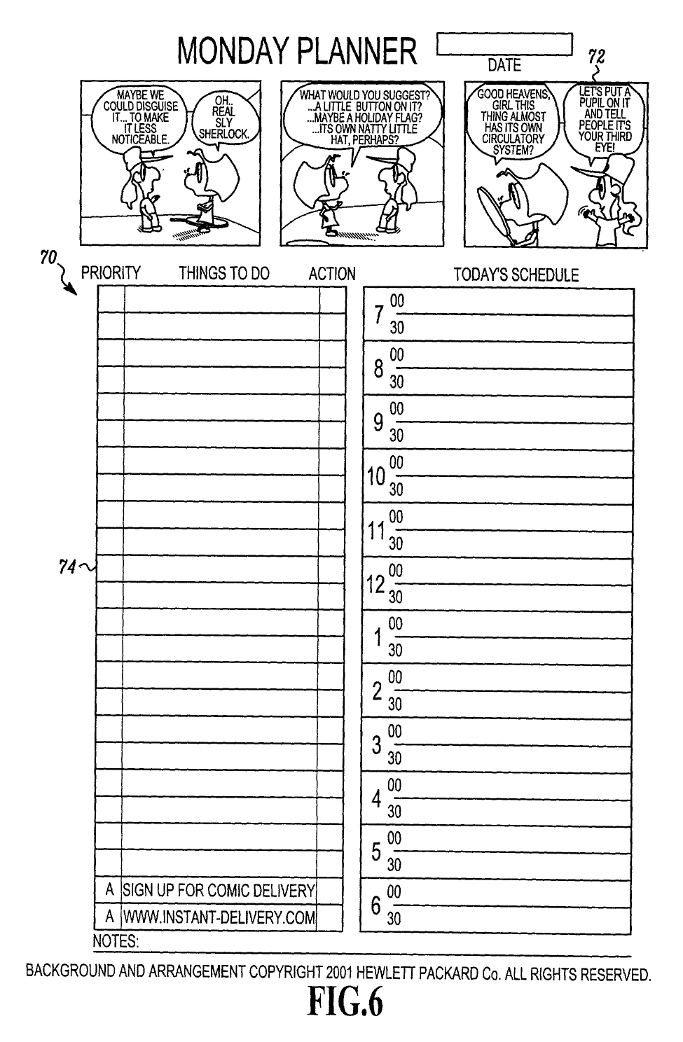

A personalized day planner page, generated in accordance with the present invention, is illustrated in FIG. 6. Referring briefly to FIG. 6, the personalized day planner page 70 includes a comic strip 72 placed over a background image 74, comprising a to-do list and a daily schedule partitioned in one-half hour increments. Although shown as being positioned along the top portion of the day planner page, the comic strip 72 or other suitable foreground image can be positioned relative to any portion of the boundary of the day planner page. For example, the comic strip 72, or suitable foreground image, can be positioned along the bottom portion or either side portion of the day planner page (e.g. background image) 74. In addition, the comic strip 72 can also be positioned about the central or other segmented portion of the background image 74.

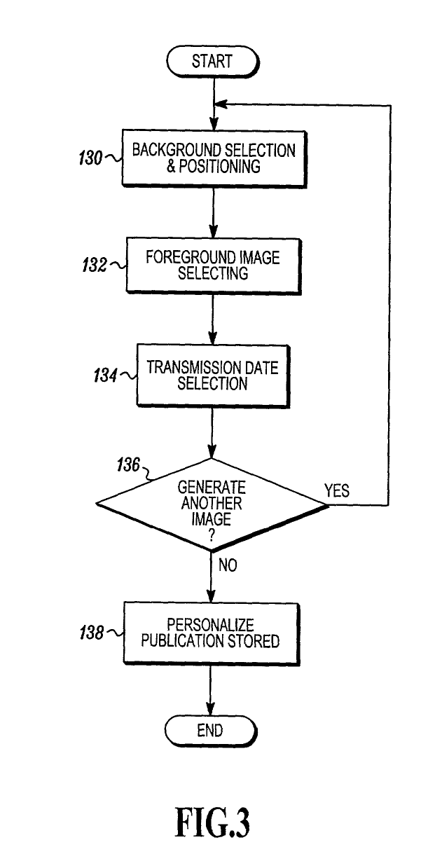

An exemplary method used to generate the personalized day planner page as illustrated in FIG. 6, will be described with reference to FIG. 3. The process begins with the user, present at client station 12, connecting to the publication/delivery engine 18 via network connection 16. Once connected, the publication/delivery engine 18 connects to the image server 20 which includes a plurality of background images from which to choose. For purposes of explanation and illustration, assume that the user has selected the daily calendar page in step 130 to act as the background image and defines the position that a subsequently selected foreground image will occupy. In an exemplary embodiment, the background image can be generated through the use of the various templates provided by the software application package QuarkXpress™, manufactured by Quark Technology Partnership.

After the background has been generated, the foreground image is selected in step 132. In an exemplary embodiment, comic strip 72 will be selected in step 132. This step can be performed by the user by placing an identifier relating to the particular file containing the comic strip at the location within the background image where the comic strip is to be located.

Next, the user is queried for a date to begin transmitting the personalized calendar generated in steps 130 and 132 to the user. In step 134, the user enters the date to begin the transmissions along with the location to send the transmissions (i.e. address of client station 12). The publication or delivery dates can be defined as being a one-time event, or a continuous event. For example, the user may select that the personalized calendar be first delivered on [Month_Start, Day_Start, Year_Start] and continue until [Month_End, Day_End, Year_End]. Or the user may enter only a single date indicating that the corresponding personalized publication is to be delivered only once. The data representing the components of the personalized calendar (e.g. background and foreground images) and the date to begin transmitting the same may then be transmitted to the staging area or other suitable location.

At step 136, the user is queried as to whether another personalized image is to be created. If no additional images are to be generated, the previously generated personalized calendar is transmitted to a suitable storage location for subsequent acquisition and delivery. On the other hand, if an additional image is to be generated, the process moves back to step 130.

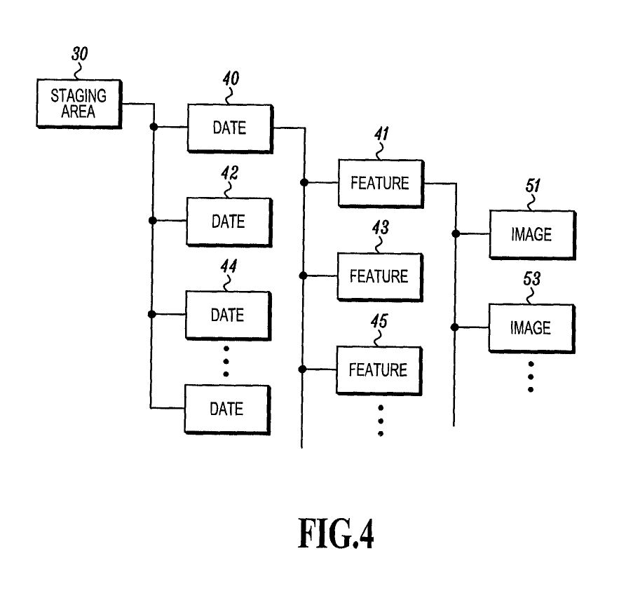

At the end of the personalized calendar generation process, the user-defined information relating to the background and foreground images which will comprise the personalized calendar are transmitted to the staging area 30 of the publication/delivery engine 18 via line 31. As illustrated in greater detail in FIG. 4, the staging area 30 (FIG. 2) is configured as a data structure containing a series of folders (40, 42, 44, etc.) for specifying the dates that the corresponding personalized images are to be transmitted to the user; a series of folders (41, 43, 45, etc) for specifying the plurality of foreground images such as comic features to be associated with the background images (i.e. day planner page) of interest which are defined through a series of folders (51, 53, etc.). Thus, a series of different publications may be defined by or on behalf of the user with a given background being associated and/or combined with several different foreground images.

The image folders (51, 53, etc.) specify an identifier of the template or actual image to be used as the background. As discussed above, the background can be, for example, a daily planner, a monthly planner, a piece of note paper, or any suitable template. In the exemplary embodiment, image folder 51 will contain the identifier for the daily planner. The feature folders (41, 43, etc.) specify the foreground image(s) that are to be an overlay to the background image. Examples of such foreground images include comic strips, quotes or images. In the exemplary embodiment, feature folder 41 will contain the identifier for the comic strip 72.

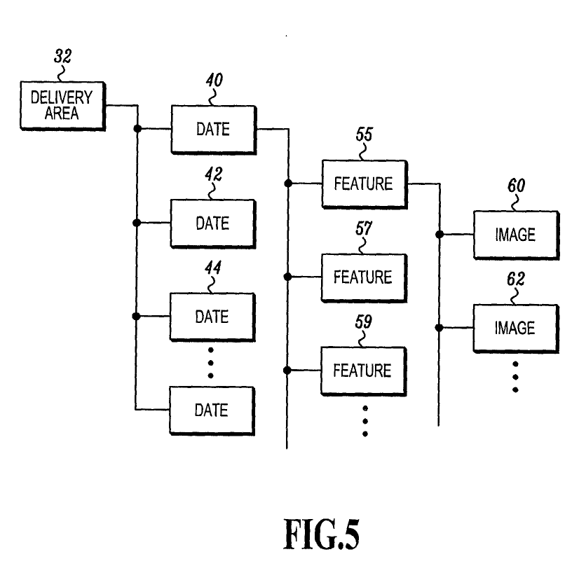

Referring briefly to FIG. 5, illustrated therein is the delivery area 32 of the publication/delivery engine 18. As shown, the delivery area 32 is comprised of a data structure containing a series of date folders (40, 42, 44, etc.), similar to that maintained in the staging area 30, for specifying the dates that the corresponding generated personalized publication is/are to be transmitted to an identified user; a series of folders (60, 62, etc.) specifying the foreground image of interest; and a series of folders (55, 57, etc.) specifying the feature of interest. For example, the first image folder 60 may contain several different completed documents that include the background images (e.g. grid, note paper, day planner) with a feature image (e.g. comic feature, quote) specified for feature folder 55 corresponding to the date specified in folder 40.

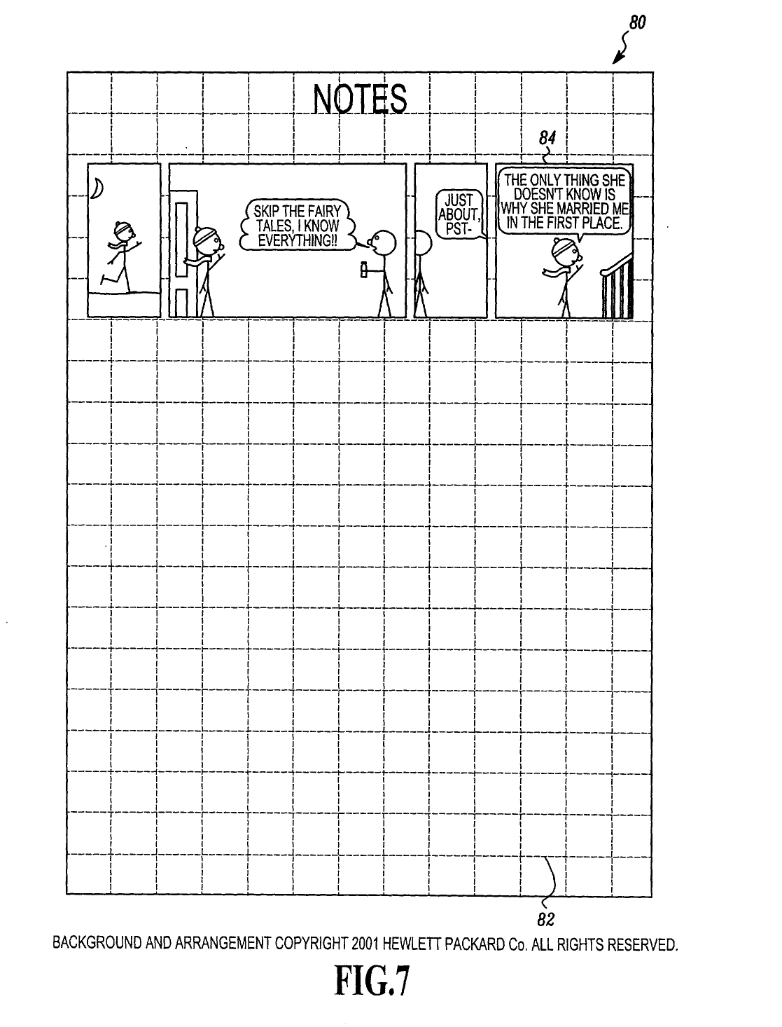

Although described as being a day planner, the personalized publication of the present invention can take other forms. An alternate publication is illustrated in FIG. 7. Shown therein is a sheet of note paper 80, including a background containing a plurality of grid lines 82 and a comic strip 84 present as the foreground image. As with the daily calendar page illustrated in FIG. 6, this sheet of note paper can be printed out by the user on printer 13 (FIG. 1). As the resulting personalized publication can be printed on a user's printer, the color and other features of the foreground image will be of higher quality than that generally provided by mass published and distributed publications.

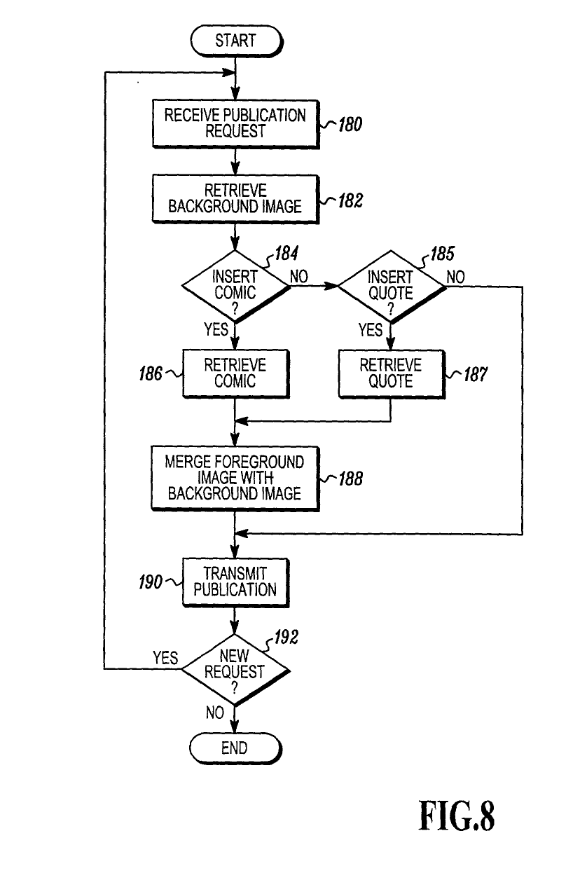

Referring now to FIG. 8, an exemplary process for transmitting the personalized electronic publication from the delivery engine to a client station is described. Initially, the request for a personalized publication is received in step 180. The background image of the corresponding publication is retrieved in step 182. This step can be performed by the image server transmitting the background image data to the publication delivery engine.

Next, in step 184, a determination is made as to whether a comic strip is to be inserted in the retrieved background image. If a comic strip is to be inserted therein, the appropriate comic strip is retrieved in step 186. This step can be performed by the comics server transmitting the appropriate comic strip data to the publication/delivery engine.

Once the background image and the foreground image have been retrieved, the images are then merged in step 188, with the resulting publication being transmitted in step 190. This step can be accomplished by, the merged background and foreground images being transmitted to the client station 12 via network connection 16 on line 21 as a publication.

In step 192, a determination is made as to whether a new publication request has been received. If a new request has been received, the process moves back to step 180 where a subsequent publication is formed. On the other hand, if no new request is received, the process ends.

Referring back to decision block 184, if it is determined that a comic strip is not to be inserted over the previously retrieved foreground image, the process proceeds to step 185 where a determination is made as to whether a quote is to be inserted over the background image. If a quote is to be inserted in the background image, the appropriate quote from quote server 24, will be retrieved in step 187. This step can be accomplished by the quotes server transmitting data comprising the appropriate quote to the publication/delivery engine. After the identified quote has been retrieved, the process moves to step 188 where the previously retrieved backgrounds and the retrieved quote foreground images are merged together and then transmitted to the client station 12 in step 190.

If it is determined in step 185 that a quote is not to be placed within the background image, the process proceeds to step 190 where the retrieved background image is transmitted to the client station 12 without any additional information being provided thereto. Thus, as described above, the publication/delivery engine 18 is capable of transmitting user-defined publications either in a one-time fashion or in a continual fashion based on a user entered start and end date.

If either the foreground image or the background image of the personalized publication to be sent or presented to the user is generated and/or provided by a commercial entity, advertising for such entity or a related entity may be attached to or transmitted within the publication. In this fashion, only advertisements of interest to the user will be provided to the user according to the user-defined criteria that is maintained within the staging area 30 of the publication/delivery engine 18. This will have the added effect of the user viewing such advertisements and, potentially, visiting the entity that provided such advertisement.

The transfer of user-specific publications may also be implemented as a subscription service, where a service provider maintains the foreground and background information to be provided to the user and the processor for merging the same on a server for a fee. In conjunction with such a subscription service, a user, for example, located at client station 12, may pay a subscription fee to receive a personalized day planner as illustrated in FIG. 6. As the publication's principal use is to entertain the user, having a user specify the particular comics, quotes or images of interest to the service provider, and presenting the user with personalized daily publications, will promote greater entertainment and value to the corresponding publication and delivery subscription service. In addition, additional revenue may be generated by having advertisers pay the service provider for providing their entertainment pieces as a potential foreground or background image.

The above detailed description of the invention and the examples described therein have been presented for the purposes of illustration and description. It is therefore contemplated that the present invention cover any and all modifications, variations or equivalents that fall within the spirit and scope of the basic underlying principles disclosed and claimed herein.

We claim:

1. A system for generating a personalized publication, comprising:
a processor; and
a memory, coupled to the processor, the memory containing instructions that when executed by the processor cause the processor to receive information identifying a background template and a foreground image; acquiring the background image from a network resource; acquiring the foreground image from a network resource; and merging the background template and the foreground image.

2. The system of claim 1, wherein the processor further includes means for connecting to the network resource for acquiring the background template and the foreground image.

3. The system of claim 1, wherein the processor further includes a staging area for maintaining the merged background template and foreground image.

4. The system of claim 1, wherein the memory further contains instructions that when executed by the processor causes the processor to receive information defining a date for transmitting the merged background template and foreground image to a client.

5. The system of claim 4, wherein the processor further includes a delivery area for maintaining the merged background template and foreground image before being transmitted in response to the transmission date.

6. The system of claim 1, wherein the instructions when executed by the processor further cause the processor to connect to a transmission medium and transmit the merged background template and foreground image along the transmission medium.

7. A method for generating a personalized publication, comprising:
(a) retrieving a background image including foreground information, the foreground information being identified by a unique identifier;
(b) retrieving content to be maintained as the foreground information; and
(c) merging the foreground information and the background image;

8. The method of claim 7, further comprising:
(d) storing the merged foreground information and background image in a delivery area;

9. The method of claim 8, further comprising:
(e) delivering the merged foreground information and background image to a requesting location.

10. The method of claim 9, wherein the requesting location is a client station.

11. The method of claim 7, further comprising receiving a request for merged information, the request for receiving the merged information being performed before the merging step.

12. The method of claim 7, wherein the background image comprises a template.

13. The method of claim 7, wherein the foreground information retrieving step comprises:
(b1) accessing a user-defined file from a network resource; and
(b2) storing the user-defined file in a staging area.

14. The method of claim 13, wherein the user-defined file comprises one of the following: an image, a comic strip and a quote.

15. The method of claim 7, wherein the background image retrieving step further comprises:
(a1) accessing a network resource containing a plurality of background images; and
(a2) retrieving a user-defined background image from one of the plurality of background images; and
(a3) storing the user-defined background image in a staging area.

16. The method of claim 9, wherein the merged foreground information is delivered according to a user-defined schedule.

17. A method for generating a personalized electronic document, comprising:
(a) receiving information identifying a background template and a foreground image;
(b) acquiring the background template from a network resource;
(c) acquiring the foreground image from a network resource; and
(d) merging the background template and the foreground image.

18. The method of claim 17, further including:
(e) receiving a delivery date; and
(f) delivering the merged document on the delivery date.

19. The method of claim 17, wherein the information receiving step further comprises:
(a1) receiving a background type identifier; and
(a2) receiving foreground image placement information;

20. The method of claim 19, further comprising:
(a3) receiving a foreground image identifier.

21. The method of claim 17, wherein the foreground image is identified as being one of the following: a comic, an image, a quote.

22. The method of claim 19, wherein the foreground image placement information causes the foreground image to be positioned along the top, bottom, or side portions of the background template.

23. The method of claim 19, wherein the foreground image placement information causes the foreground image to be positioned about the central portion of the background template.
